(19) United States
(12) Patent Application Publication
(10) Pub. No.: US 2007/0067919 A1
(43) Pub. Date: Mar. 29, 2007

(54) Red bleaching compositions

(76) Inventors: Stephen Norman Batchelor, Bebington (GB); Sarah Dixon, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/578,031

(22) PCT Filed: Sep. 30, 2004
(86) PCT No.: PCT/EP04/10942

§ 371 Date: May 2, 2006

(30) Foreign Application Priority Data
Nov. 3, 2003 (GB) 0325617.9

(51) Int. Cl. C11D 3/00

(52) U.S. Cl. 8/115.51

(57) ABSTRACT

The present invention concerns photo-bleaching with Food red 14 (colours Index 45430) and in particular the bleaching of laundry items.

### FIELD OF INVENTION

The present invention relates to the photo-bleaching of products, in particular laundry bleaching.

### BACKGROUND OF INVENTION

In a conventional bleaching treatment, a substrate such as a laundry fabric or other textile is subjected to hydrogen peroxide, or to substances which can generate hydroperoxyl radicals, such as inorganic or organic peroxides.

A preferred approach to generating hydroperoxyl bleach radicals is the use of inorganic peroxides coupled with organic precursor compounds. These systems are employed for many commercial laundry powders. For example, various European systems are based on tetraacetyl ethylenediamine (TAED) as the organic precursor coupled with sodium perborate or sodium percarbonate, whereas in the United States laundry bleach products are typically based on sodium nonanoyloxybenzenesulphonate (SNOBS) as the organic precursor coupled with sodium perborate. Alternatively, or additionally, hydrogen peroxide and peroxy systems can be activated by bleach catalysts, such as by complexes of iron and the ligand N4Py (i.e. N,N-bis(pyridin-2-yl-methyl)-bis(pyridin-2-yl)methylamine) disclosed in WO95/34628.

Another approach to bleaching is that of using radical photo-initiators, which are generally organic chemicals which on absorption of light, particularly UV light, form reactive radicals. They are widely used to initiate the polymerisation of alkenes and thereby cure coatings. They may also be used as photobleach agents as discussed in GB 9917451. Radical photoinitiators, in general, are discussed by H. F. Gruber in Prog. Polym. Sci. Vol 17. 953-1044.

### SUMMARY OF INVENTION

We have found that Food red 14 is surprisingly active in photo-bleaching catechol-type stains, polyphenolics-type stains and polycyclic hydroxylated aromatic-type stains. The Food red 14 may be used on its own as the bleaching species or in conjunction with other bleaching species. It is preferred that those other bleaching species, if used, possess different bleaching profiles. The stain bleaching profile of known photo-bleaches is generally that of ceretenoid type stains, for example tomato stains which is similar to the bleaching profile of “air” bleaching catalysts.

These catechol-type stains, polyphenolics-type stains and polycyclic hydroxylated aromatic-type stains are as a result of the chromophores found in tea, coffee, blackberry, blueberry, blackcurrant, red wine, banana and the like. These stains are characteristic and distinct from oily food type stains such as tomato oil stain, curry oil stain, mango stain, annatto derived stain, colorau derived stain, and sebum derived stain etc.

The economic factors in cleaning products are a dominant in many decisions to launch a product. By substituting or reducing the amounts of more expensive bleaching components with Food red 14 an efficacious product may be produced with at less cost. This exemplified by the following, Food red 14 exhibits similar bleaching efficacy to that of perborate/percarbonate when used in conjunction with TAED on certain stains. Another benefit is that Food red 14 may be used in washes of lower temperature than that of the peroxyl systems. In addition, the level of Food Red 14 exhibits bleaching effects at surprisingly low levels. Of the red dyes Food Red 14 deposited effectively on the textile.

The present invention provides a bleaching composition comprising:
a) from 0.0001 wt/wt % to 0.1 wt/wt % of Food red 14 dye;
b) from 0 to 40% other bleaching species; and,
c) the balance carriers and adjunct ingredients to 100 wt/wt % of the total bleaching composition, wherein upon addition of a unit dose of the bleaching composition to an aqueous environment a wash liquor having a pH in the range 8 to 11 is provided, wherein the bleaching composition comprises less than 1 % of a peroxyl species.

The fact that Food Red 14 is brightly red makes its application in textile bleaching unusual because one would expect their use to result in discoloured rather than whitened textiles. When Food red 14 is used solely as the bleaching species the consumer is reassured in the laundry context that the bleach used is mild because of that fact that it is an acceptable a food additive. Food dyes are used to enhance the visual appearance of many foods. As humans consume them, they undergo rigorous testing and examination to ensure they represent no risk to health. In addition, a solution of Food Red 14 under indoor lighting is much paler to the eye than that of Rose Bengal, which has an intense colour in solution, despite having a lower optical density than Food red 14. This permits higher dosages of Food red 14 to be used than, for example, Rose Bengal without overly colouring the liquor.

The present invention also extends to a method of photo-bleaching a textile stain.

One method of the present invention comprises the steps of:

(i) treating a textile with a solution of Food red 14 dye,

(ii) irradiating the treated textile.

The light used for photo-bleaching may be sunlight, florescent light or that from an ordinary light bulb.

Photo-bleaching is still effective where the concentration of Food red 14 on the textile/cloth is so low as to be barely perceptible to the human eye. The Food red 14 if perceptible rapidly photo-fades.

The present invention may be applied locally, suitable pre-treatment means for application include sprays, pens, roller-ball devices, bars, soft solid applicator sticks.

A unit dose as used herein is a particular amount of the bleaching composition used for a type of wash. The unit dose may be in the form of a defined volume of powder, granules or tablet.

### DETAILED DESCRIPTION OF THE INVENTION

Food red 14 (Erythrosine B) (E 127; CI number 45430) (CAS 16423-68-0) is a widely used red food colouring, see Hunger K. Industrial Dyes: Chemistry Properties And Applications. Wiley-VCH, Heidelberg 2003.

The concentration of Food red 14 in a wash liquor is from 5 ppb to 1000 ppm, preferably loppb to 100 ppm, more preferably 50 ppb to 5 ppm, and most preferably 100 ppb to 1 ppm. A same concentration may also be used for a spot treatment of a stain or of a commercial liquid formulation. A suitable concentration in a powder detergent would be 0.0001 wt/wt % to 0.1 wt/wt %, most preferred is 0.001 wt/wt % to 0.01 wt/wt %.

Other Bleaching Species

The bleaching composition may also contain other bleaching components, for example other photo-bleaches, a transition metal catalyst which is present in a bleaching composition that is substantially devoid of peroxyl species, and peroxyl bleaching systems. An example of a preferred additional photo-bleach is vitamin K3.

The use of bleaching catalysts for stain removal has been developed over recent years and may be used in the present invention. Examples of transition metal catalysts that may be used are found, for example, in: WO0060045, WO0248310, WO0029537 and WO0012667. The catalysts may be used for catalysing peroxyl or “air” bleaching as described in WO0248301. The catalyst may alternatively be provided as the free ligand that forms a complex in situ.

The bleaching composition when use as an “air” bleaching composition is substantially devoid of a peroxygen bleach or a peroxy-based or peroxyl-generating bleach system. It is believed that adventitious hydroperoxides within an oily stain serve to bleach the stain together with the catalyst. The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation (with or without an “air” bleaching catalyst) contains less that 1% wt/wt total concentration of peracid or hydrogen peroxide or source thereof, preferably the bleaching formulation contains less that 0.3% wt/wt total concentration of peracid or hydrogen peroxide or source thereof, most preferably the bleaching composition is devoid of peracid or hydrogen peroxide or source thereof.

The method of bleaching a textile stain may have peroxyl species present. If peroxyl species are present the method, it is preferred that sodium percarbonate or perborate is used in the method.

Balance Carriers and Adjunct Ingredients

The following provides examples of suitable balance carriers and adjunct ingredients.

These are generally surfactants, builders, foam agents, anti-foam agents, solvents, and enzymes. The use and amounts of these components are such that the bleaching composition performs depending upon economics, environmental factors and use of the bleaching composition. It is preferred that the bleaching composition comprises from 5 to 40 wt/wt % of a surfactant having an HLB greater than 15.

To that extent, the composition comprises a surfactant and optionally other conventional detergent ingredients. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₆ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher.acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

The composition may contain additional enzymes as found in WO 01/00768 Al page 15, line 25 to page 19, line 29, the contents of which are herein incorporated by reference.

Builders, polymers and other enzymes as optional ingredients may also be present as found in WO0060045.

Suitable detergency builders as optional ingredients may also be present as found in WO0034427.

The composition of the present invention may be used for laundry cleaning, hard surface cleaning (including cleaning of lavatories, kitchen work surfaces, floors, mechanical ware washing etc.). As is generally known in the art, bleaching compositions are also employed in waste-water treatment, pulp bleaching during the manufacture of paper, leather manufacture, dye transfer inhibition, food processing, starch bleaching, sterilisation, whitening in oral hygiene preparations and/or contact lens disinfection.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate.

### EXAMPLES

### Example 1

A 1.5 g/L stock solution of a base washing powder was created. The washing powder contained 18% NaLAS, 73% salts (silicate, sodium tripolyphosphate, sulphate, carbonate), 3% minors including perborate, fluoreser and enzymes, remainder impurities and water. The solution was divided into 4, 200 ml aliquots. To each was added various amounts of the food red 14, and then 2 BCl test clothes and 4 white cotton clothes. All clothes were the same size and weight, the total weight of cloth added was 5 g. BCl is a standard stained test cloth used in laundry evaluation and is a model tea stain monitor. BCl clothes may be purchased from e.g., the center for test materials, Vlaardingen, NL.

The clothes were then agitated in solution for 20 mins, removed rinsed and the 2 BCl clothes and 2 of the white clothes irradiated in a weatherometer (WOM) for 30 minutes. A WOM produces artificial sunlight and was set up to give 385 W/m² in the UV-visible range. The remaining 2 white clothes were dried in the dark in a tumble drier.

Following these procedures the colour of the clothes were measured using a reflectance spectrometer and expressed as the DeltaE relative to washed clean white cloth. The results are presented in the table below

| [Acid red 51] g/L | BC1 | White - irradiated | White - dark |
|---|---|---|---|
| 0 | 19.1 | 1.9 | — |
| 0.001 | 17.5 | 1.2 | 2.1 |
| 0.002 | 16.4 | 0.9 | 4.2 |

Clear photo-bleaching of the BCl stain is observed. A small amount of red colouration is transferred to the white cloth. This red colouration is removed by exposure to sunlight.

### Example 2

A 1 g/L SDS surfactant stock solution in water was created. The solution was divided in two and the two halves, and buffered to pH 10 and pH 8 respectively using standard salts (Hydrion™ buffer, purchased from Sigma-Aldrich). The solution was used to wash BCl stains as follows. A 3.7 g piece of BCl stained cotton cloth plus a 0.7 g piece of clean white woven cotton cloth were agitated in 100 ml of wash solution for 20 mins, rinsed twice, then the BCl cloth irradiated in a WOM for thirty minutes. The DeltaE of the clothes relative to a clean standard was then measured. The clothes were then irradiated for a further 30 minutes and remeasured.

The experiment was repeated using wash solution containing different amounts of Food red 14. The optical density (5 cm) of the wash solutions were measured at the lambda (max) of the dye (527 nm)

All the white clothes were tumbled dried in the dark and the pick up of red dye measured by measuring the DeltaE of the clothes relative to a clean undyed standard.

The results are reported in the table below:

TABLE

| | | | DeltaE | DeltaE | DeltaE |
|---|---|---|---|---|---|
| ppm dye in | | Optical | (BC1)¹ | (BC1)¹ | (white |
| solution | pH | density | 30 mins | 6′0 mins | cloth)² |
| 0 | 8 | 0 | 17.3 | 16.9 | 0.5 |
| 0.1 | 8 | 0.08 | 16.0 | 15.7 | 1.1 |
| 0.3 | 8 | 0.16 | 14.8 | 14.4 | 2.3 |
| 0.8 | 8 | 0.36 | 14.2 | 13.7 | 4.7 |
| 3.8 | 8 | 1.78 | 10.6 | 9.9 | 14.6 |
| 0 | 10 | 0.0 | 17.2 | 16.8 | 0.5 |
| 0.1 | 10 | 0.09 | 15.8 | 15.4 | 0.9 |
| 0.3 | 10 | 0.14 | 15.0 | 14.6 | 1.9 |
| 0.8 | 10 | 0.36 | 12.1 | 11.7 | 4.1 |
| 3.8 | 10 | 1.71 | 9.4 | 8.8 | 13.8 |

¹average of 4 independent measurements
²average of 2 independent measurements

Photobleaching of the BCl stain was observed from all solution containing food red 14. Notably this occurs even at extremely low levels of the dye, 0.1 ppm, at this level the dye is barely visible in solution and no red colour could be discerned by eye on the white cloth. However the BCl cloth was visibly bleached. The red colour on the white cloth was removed simply by leaving in natural light.

### Example 3

Stains were created on white woven cotton by: placing 1 drop of (a) a saturated solution of turmeric in soya oil or (b) placing 2 drop of Brazilian palm oil.

Three of each type of stains (a), (b), BCl stains and four clean white ballast pieces (total weight=11.4 g) were wash at 40° C. for 20 minutes in 200 ml of water containing 7 g/L of Persil Colour™ washing powder. Persil Colour™ contains less than 5% soap. Polycarboxylate and phosphonate, 5 to 15% anionic and non-ionic surfactants, 15-30% zeolite and also contains enzymes. Following the wash the cloths were rinsed once in water, once in an acidic solution, and finally once more in water. They were then all irradiated in a WOM for 36 minutes. The residual staining and relative to clean white cloth measured using a reflectometer and expressed as the ΔE value. The discoloration of the white ballast due to transfer of coloured stain matter in the wash was measured in an analogous manner.

The experiment was repeated but with the following, added to the wash solution:

(a) 1 ppm food red 14

(b) 10 ppm vitamin K3 (a radical photo-initiator which bleaches carotenoid stains)

(c) 1 ppm food red 14 plus 10 ppm vitamin K3

The results are displayed in the table below

TABLE

DeltaE

| | BC1 | Turmeric | Palm oil | White cotton |
|---|---|---|---|---|
| Control | 16.8 | 22.5 | 23.9 | 2.9 |
| (a) | 15.5 | 22.4 | 22.8 | 2.2 |
| (b) | 16.6 | 20.7 | 8.0 | 2.5 |
| (c) | 15.0 | 19.3 | 7.6 | 1.5 |

The combination of the Food red 14 with the vitamin K3 gives good overall bleach effects.

### Example 4

A 3.7 g piece of BC1 stained cotton cloth was washed in 80 ml of a pH=10 buffered solution of 0.2 g/L SDS. The wash consisted in a 15 minute agitation followed by rinsing. The cloth was then irradiated in a WOM for 30 minutes and the residual staining measured as the DeltaE relative to clean white cotton. The experiment was also performed with wash liquors containing various xanthene type dyes. The % deposition of the dyes onto the cloth was obtained by measuring the UV-VI spectrum of the wash liquors before and after washing. The results are shown in the table below.

TABLE

| Dye | Amount of dye | BC1 DeltaE¹ | % deposition |
|---|---|---|---|
| Control | — | 17.7 | — |
| Eosin B | 2.2 ppm | 18.1 | 35 |
| Eosin Y | 2.2 ppm | 12.9 | 52 |
| Phloxine B | 2.1 ppm | 14.0 | 9 |
| Rose | 2.2 ppm | 10.8 | 19 |
| Bengal | | | |
| Food Red 14 | 2.2 ppm | 10.9 | 44 |

¹average of 4 independent measurements

From the results Food red 14 and Rose Bengal provide superior bleaching.

| Name | Dye Anion Structure |
|---|---|
| Eosin B | 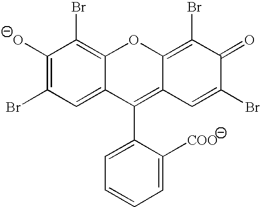 |
| Eosin Y | 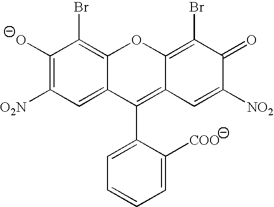 |
| Phloxine B | 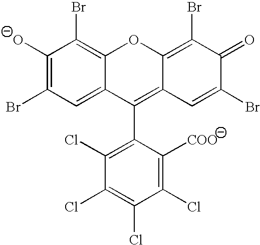 |
| Rose Bengal | 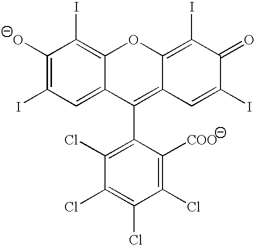 |
| Food Red 14 | 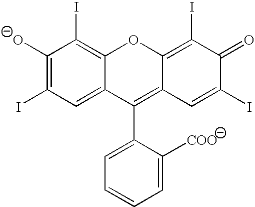 |

### Example 5

A stock solution of 1.5 g/L of a base washing powder in water was created. The washing powder contained 18% NaLAS, 73% salts (silicate, sodium tri-poly-phosphate, sulphate, carbonate), 3% minors including perborate, fluorescer and enzymes, remainder impurities and water. The solution was divided into 60 ml aliquots and various combination of food red 14 dye with acid blue 29 added to this in amount as indicated in the results table. 1 piece of bleached, non-mercerised, non-fluorscent woven cotton cloth (ex Phoenic Calico) weighing 1.3 g was placed in the solution at room temperature (20° C.). This cloth represents a slightly yellow cotton. The cloth was left to soak for 45 minutes then the solution agitated for 10 mins, rinsed and dried in the dark. After the washes the Ganz whiteness of the cloth was measured (see “assessment of Whiteness and Tint of Fluorescent Substrates with Good Interinstrument Correlation” Colour Research and Application 19, 1994). A higher value of Ganz is associated with whiter cloth. The results are the average of 2 experiments.

TABLE

| Food Red 14/ppm | Acid Blue 29/ppm | Ganz |
|---|---|---|
| 0 | 0 | 147 |
| 0.18 | 0 | 150 |
| 0.135 | 0.058 | 150 |
| 0.09 | 0.117 | 158 |
| 0.045 | 0.175 | 162 |
| 0 | 0.233 | 170 |
| 0.09 | 0 | 146 |
| 0.067 | 0.029 | 152 |
| 0.045 | 0.058 | 156 |
| 0.022 | 0.087 | 160 |
| 0 | 0.117 | 163 |

Mixture of food red 14 with the blue dyes gives an increase in the whiteness of the cloth.

The dye acid black 1 gave similar results.

### Example 6

The experiment of example 5 was repeated. Except here one 3.7 g piece of BC1 stained cotton cloth was washed in 60 ml of solution containing various amounts of food red 14 and acid blue 29. The wash consisted of 30 minutes of agitation. Following the rinses the clothes were irradiated in a WOM for 30 minutes and the residual stain measured as the ΔE relative to clean white cloth. The results are shown in the table below.

TABLE

| Food red 14/ppm | Acid blue 29/ppm | BC1 DeltaE¹ |
|---|---|---|
| 0 | 0 | 16.9 |
| 0.18 | 0 | 16.2 |
| 0.135 | 0.058 | 16.1 |
| 0.09 | 0.117 | 16.4 |
| 0.045 | 0.175 | 16.7 |

¹average of 4 independent measurements.

Hence the mixture of dyes gives photo-bleach effects and shading benefit (example 5).

### Example 7

A solution of 0.2 g/L SDS surfactant was created in pH=10 buffer (Hydrion™). The solution was divided in 2 and RoseBengal added to one half such that its Optical density at the maximum absorption of the dye in the visible was 0.81 (5 cm). A similar solution was created for Food Red 14 but with a higher optical density of 0.93. The Solution of Food Red 14 under indoor lighting was much paler to the eye than that of Rose Bengal. This was confirmed by 12 independent adults aged in the range 25-60 years. All stated the Rose Bengal solution to have a more intense colour, despite the fact it had a lower optical density. This clearly shows the advantage in being able to dose Food red 14 at a higher level without over colouring the liquor.

1. A bleaching composition comprising:
c) from 0.0001 wt/wt % to 0.1 wt/wt % of Food red 14 dye;
d) from 0 to 40% other bleaching species; and,
c) the balance carriers and adjunct ingredients to 100 wt/wt % of the total bleaching composition, wherein upon addition of a unit dose of the bleaching composition to an aqueous environment a wash liquor having a pH in the range 8 to 11 is provided, wherein the bleaching composition comprises less than 1% of a peroxyl species.

2. A bleaching composition according to claim 1, wherein the Food red 14 bleaching composition is present in the range of 0.001 to 0.01 wt/wt %.

3. A bleaching composition according to claim 1, wherein the bleaching composition comprises other photo-bleaches.

4. A bleaching composition according to claim 3, wherein the bleaching composition comprises vitamin K3.

5. A bleaching composition according to claim 1, wherein the bleaching composition comprises an air bleach catalyst or ligand thereof.

6. A bleaching composition according to claim 1, wherein the bleaching composition is a liquid bleaching composition.

7. A bleaching composition according to claim 1, wherein the bleaching composition comprises from 5 to 40 wt/wt % of a surfactant having an HLB greater than 15.

8. A bleaching composition according to claim 1, wherein the bleaching composition is devoid of a peroxygen species.

9. A method of bleaching a textile stain, the method comprising the steps of:
(i) treating a textile with a solution of Food red 14 dye,
(ii) irradiating the treated textile.

10. A method according to claim 9, wherein the solution comprises from 100 ppb to 1 ppm of Food red 14 dye.

11. A method according to claim 9, wherein the method further comprises a step of drying the textile.
